(19) United States
(12) Patent Application Publication
(10) Pub. No.: US 2005/0100700 A1
(43) Pub. Date: May 12, 2005

(54) Extruded tubular profile made of a material such as fiberglass-reinforced plastics, and associated extrusion machine for making the profile

(76) Inventor: Cesare Frabbi, Mezzolara di Budrio (IT)

Correspondence Address: MODIANO & ASSOCIATI, Via Meravigli, 16, 20123 MILANO-ITALY, EUROPE, IT

(21) Appl. No.: 10/976,801

(22) Filed: Nov. 1, 2004

(30) Foreign Application Priority Data
Nov. 6, 2003 (IT) BO2003A000654

(51) Int. Cl. B29C 47/02; B32B 1/08

(52) U.S. Cl. 428/36.4; 425/113; 425/114; 428/36.9

(57) ABSTRACT

An extruded tubular profile made of a material such as fiberglass-reinforced plastics, and an associated extrusion machine, which comprises at least one longitudinal strand of pretreated glass fibers embedded, while hot, in the thickness of the profile during extrusion, the extrusion machine being provided with a unit for preheating the strand.

The present invention relates to an extruded tubular profile made of a material such as fiberglass-reinforced plastics and to an associated extrusion machine for making the profile.

### BACKGROUND OF THE INVENTION

In the particular field of extruded profiles made of a material such as plastics, for example polyethylene, polypropylene or others, the low flexural strength of these profiles is known and is showing even when the profile is used as a handle or as an extension.

Extruded profiles made of plastic material reinforced with glass fibers distributed throughout the mass of the profile in a relatively uniform manner are known: in these profiles, the reinforcing fibers surface in certain points of the mass, becoming rather unpleasant aesthetically.

Moreover, it has been found that when excessively viscous plastic material is used in producing articles reinforced with glass fibers that are concentrated in certain sections in the mass of the plastic material, said material is unable to impregnate the glass fibers, which accordingly do not become monolithic with the plastic material.

### SUMMARY OF THE INVENTION

The aim of the present invention is to provide extruded profiles reinforced with glass fibers in which the fibers are present only inside the mass of plastic material and are not present at the surface and to provide an extrusion machine that allows to provide fiberglass-reinforced profiles of any kind.

Within this aim, an object of the present invention is to provide an extruded profile that is simple, relatively easy to provide in practice, safe in use, effective in operation, and has a relatively low cost.

This aim and this and other objects that will become better apparent hereinafter are achieved by the present extruded tubular profile made of a material such as fiberglass-reinforced plastics, with an associated extrusion machine for making the profile, characterized in that it comprises at least one longitudinal strand of pretreated glass fibers that is embedded, while hot, in the thickness of the profile during extrusion thereof on the extrusion machine that is provided with a unit for preheating said strand.

### BRIEF DESCRIPTION OF THE DRAWINGS

Further characteristics and advantages of the present invention will become better apparent from the following detailed description of a preferred but not exclusive embodiment of an extruded tubular profile made of a material such as fiberglass-reinforced plastics and of the associated extrusion machine according to the invention, illustrated by way of non-limiting example in the accompanying drawings, wherein:

FIG. 1 illustrates a plurality of sectional views of profiles reinforced with glass fibers according to the invention;

FIG. 2 is a schematic side view of an extrusion machine for providing the profile;

FIG. 3 is a front view of the inlet of an extruder equipped to provide the profile according to the invention;

FIG. 4 is a sectional front view, taken along a central plane of said extruder;

FIG. 5 is a rear view of the outlet of the extruder.

### DESCRIPTION OF THE PREFERRED EMBODIMENTS

With reference to the figures, the reference numeral 1 designates an extruded tubular profile made of a material such as plastics reinforced with glass fibers and the reference numeral 2 designates the corresponding extrusion machine for making the profile; the plastic-like material used can be polyvinyl chloride, polyethylene, polypropylene, ABS and any thermoplastic material.

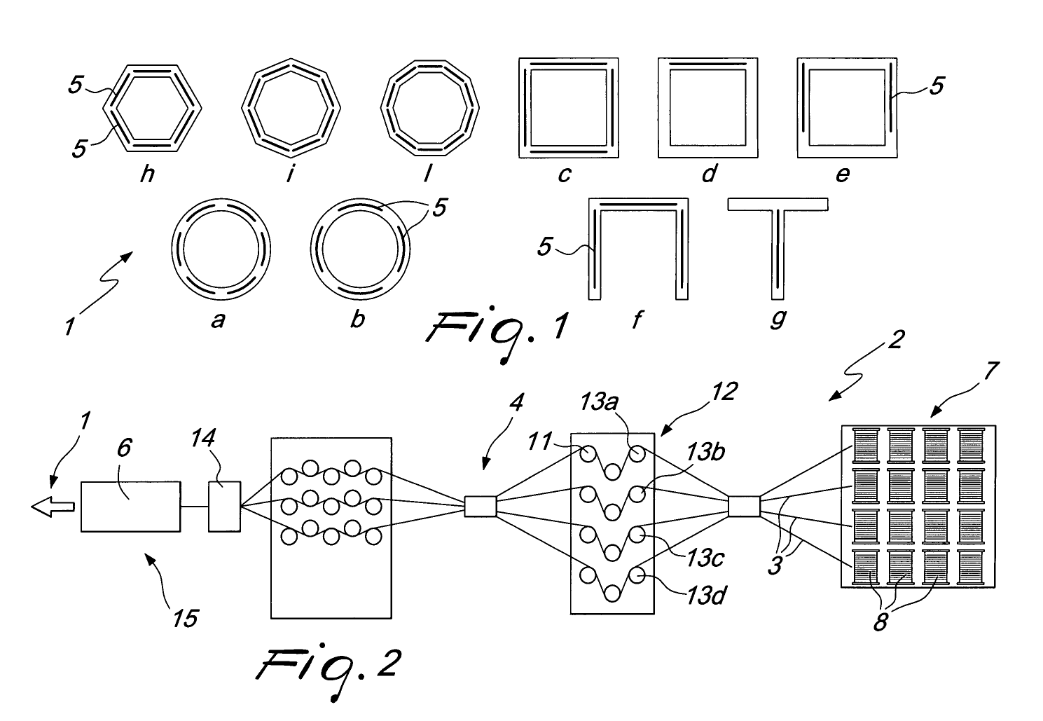

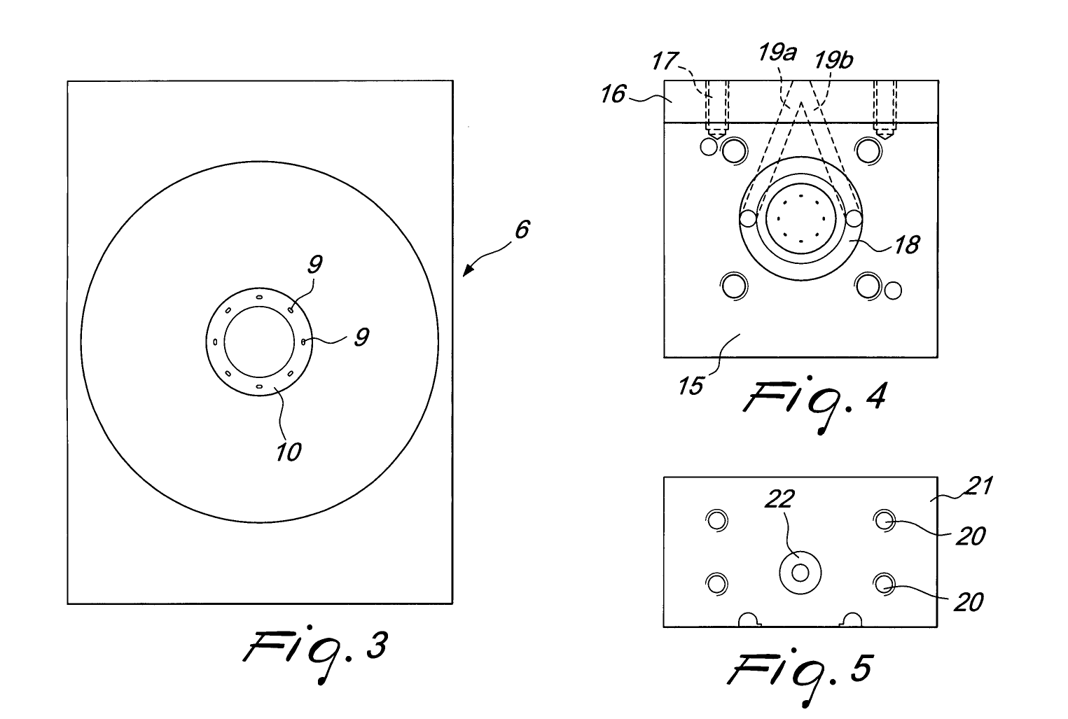

The profile 1 can have any cross-section (round, square, hexagonal, octagonal, decagonal, oval or others) and is reinforced with at least one strand 3 made of glass fibers: FIG. 1 shows, by way of example, some cross-sections of the profile a, b, c, d, e, f, g, h, i, l, in which strands, grouped or distributed in particular bands, are distributed.

The strands 3 are embedded while hot in the thickness of the profile during extrusion, and are made of pretreated glass fibers: the extrusion machine 3 is provided with a unit 4 for preheating the strand.

The strand 3 is (pre)treated, in that it is impregnated, while hot, with materials such as plastics and then cooled and collected on a reel 8.

The strands may be a plurality, grouped side by side, so as to form one or more bands 5.

The profile 1 has a preferably tubular hollow cross-section that is shaped like a regular or irregular polygon, and in which the band or bands 5 of strands are distributed along one or more sides of the polygon.

The machine 2 comprises a magazine 7, which is arranged upstream of an extrusion head 6 for plastic material and supports rotatably a plurality of reels 8 for winding pretreated strands: each strand is guided in a respective hole 9 of a rearward front plate 10 of the extrusion head 6.

A comb-like array 12 of rollers 13 is arranged between the magazine 7 of reels of strand and the plate 10 rigidly coupled to the extrusion head; the rollers 13 are distributed on various planes 13a, 13b, 13c, and are arranged in the sequence I, II, III, IV; the strands are made to pass in a zigzag fashion over the series of co-planar rollers, which are provided with heating elements for example of the electric resistor type 11, which are suitable to bring to a pasty consistency the material that impregnates the strand, in order to allow the intimate adhesion of the strand to the profile that is gradually extruded.

Before entering the extruder, the strands are made to pass through a heated distribution unit 14, which distributes the strands so that they are arranged tidily in bands 5 constituted by groups of strands 3 arranged side by side.

The extrusion head 6 is constituted by a block 15, which is made of metallic material and is provided with a massive cover 16; said cover and said block can be fixed together by means of bolts 17, and in said block there is an axial duct 18 for the forced advancement of the plastic material to be extruded in the pasty state, which arrives from two inclined feed ducts 19a and 19b.

The plate 10 is fixed to the face of the extrusion head that is directed toward the distribution unit 14 and is crossed by holes 9 that correspond to the regions where the bundle of strands enters the die: a body 21 shaped like a parallelepiped can be fixed detachably, by means of bolts 20, on the other face of the extruder, and the outer surface of the body 21 forms an extrusion section 22, which in the particular case is tubular.

The operation of the invention is intuitive: given a profile having any cross-section that can be obtained by extrusion, the regions where the reinforcement fibers are to be arranged are determined according to the intended use.

The strands are made to pass in a zigzag fashion over the rollers of the heating array and then through the holes 9 of the plate 10 in the extrusion head, where an intimate cohesion between the fibers and the plastics occurs because the plastic material with which the strands have been pretreated is consistent with the material that constitutes the profile: for a profile made of a material such as xxxx, and PVC or polyethylene, the strand is pretreated with material such as respectively PVC and polyethylene or other compatible material.

It has thus been shown that the invention has achieved the intended aim and object.

The invention thus conceived is susceptible of numerous modifications and variations, all of which are within the scope of the appended claims.

All the details may further be replaced with other technically equivalent ones.

In the embodiments that follow, individual characteristics, given in relation to specific examples, may actually be interchanged with other different characteristics that exist in other embodiments.

Moreover, it is noted that anything found to be already known during the patenting process is understood not to be claimed and to be the subject of a disclaimer.

The embodiment of the present invention shall be carried out in the most scrupulous compliance with the statutory and regulatory provisions related to the products of the invention or correlated thereto and following any required authorization of the corresponding competent authorities, with particular reference to regulations related to safety, environmental pollution and health.

In practice, the materials used, as well as the shapes and dimensions, may be any according to requirements without thereby abandoning the protective scope of the appended claims.

The disclosures in Italian Patent Application No. BO2003A000654 from which this application claims priority are incorporated herein by reference.

1. An extruded tubular profile composed of a plastic material extruded on an extrusion machine so as to have a selected configuration and thickness, and at least one longitudinal strand of pretreated glass fibers that is preheated on said extrusion machine and is embedded in the thickness of said profile during extrusion, and while the profile is hot.

2. The profile of claim 1, wherein said at least one pretreated strand is provided pretreated by way of impregnation in a hot state with plastic materials, cooled and collected in a reel.

3. The profile of claim 2, comprising a plurality of said strands grouped side by side in at least one band.

4. The profile of claim 3, having a hollow tubular cross-section, which is shaped as a polygon having any of a regular or irregular configuration, in which said band of strands is distributed on at least one side of the polygon.

5. An extrusion machine for making a tubular profile as set forth in claim 1, comprising: a magazine for rotatably supporting a plurality of reels for winding and unwinding strands pretreated by impregnation with a plastic material, and an extrusion head for plastic material arranged downstream of said magazine and having a front rearward plate provided with through holes for guiding therethrough respective strands of glass fiber.

6. The machine of claim 5, further comprising a comb-like array of rollers arranged between said magazine of strand reels and said front rearward plate, said rollers being distributed on various planes and being provided with heating elements, for bringing to a pasty state the material that impregnates the strands, in order to allow adhesion of the strand to the extruded profile.

7. A method for making an extruded tubular profile with an extrusion machine, as set forth in any of the claims 5-6, comprising: extruding on said machine a profile of a plastic material; heating, in a heating unit of the extrusion machine, pretreated longitudinal strands of glass fiber; and embedding said heated strands of glass fiber in said profile while hot.
